(19) United States
(12) Patent Application Publication
(10) Pub. No.: US 2024/0266871 A1
(43) Pub. Date: Aug. 8, 2024

(54) PROCESS FOR EFFICIENT STORAGE AND PROVISION OF ENERGY

(71) Applicant: Siemens Energy Global GmbH & Co. KG, Münich, Bayern (DE)

(72) Inventors: Christian Hüttl, Forchheim (DE); Peter Rop, Benthuizen (NL); Jochen Schäfer, Nürnberg (DE)

(73) Assignee: Siemens Energy Global GmbH & Co. KG, Munich, Bayern (DE)

(21) Appl. No.: 18/566,418

(22) PCT Filed: May 12, 2022
(86) PCT No.: PCT/EP2022/062912

§ 371 Date: Dec. 1, 2023

(30) Foreign Application Priority Data
Jun. 8, 2021 (DE) 10 2021 205 769.1

(51) Int. Cl. H02J 15/00; C25B 1/04

(52) U.S. Cl. CPC H02J 15/008; C25B 1/04; H02J 2300/30

(57) ABSTRACT

A system for efficient conversion and provision of electrical energy, wherein supplied electrical current is converted into hydrogen in an electrolyzer and optionally temporarily stored in hydrogen storage. The hydrogen is converted into electrical current in a conversion stage in which offgas containing water in vapor form is emitted. The offgas is cooled using a heat pump to obtain condensate which is supplied to the electrolyzer as feed water. As a result, a supplied electrical current is decoupled from generated electrical current, wherein utilization of the process heat provided by the heat pump makes it possible to achieve high efficiency coupled with a low demand for fresh water for the electrolyzer.

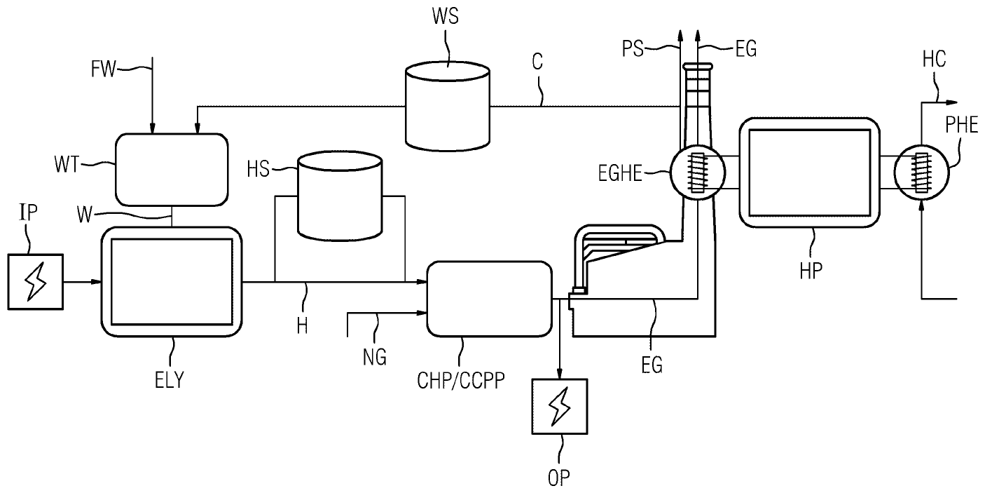

### CROSS REFERENCE TO RELATED APPLICATIONS

This application is the US National Stage of International Application No. PCT/EP2022/062912 filed 12 May 2022, and claims the benefit thereof, which is incorporated by reference herein in its entirety. The International Application claims the benefit of German Application No. DE 10 2021 205 769.1 filed 8 Jun. 2021.

### FIELD OF INVENTION

The invention pertains to a combined heat and power process where current can be both accommodated and delivered.

The invention relates to a method for efficient and resource-sparing conversion and provision of electrical and/or thermal energy, as well as electrical energy, having the features of the independent claim.

### BACKGROUND OF INVENTION

The transformation of electrical energy supply, with increasing incorporation of renewable energies with their fluctuating supply, imposes particular challenges on the 24/7 balancing-out of supply of and demand for electrical energy.

It requires facilities for the conversion of electrical energy, whether for temporary storage— in the short term, over seconds, or in the long term, over days— or for conversion of frequency and phase. For these applications it is important that the facilities operate in a highly efficient manner.

The generation of hydrogen by electrolysis, using electricity and water, and the subsequent storage of this hydrogen, are part of known practice. Additionally known is the conversion of hydrogen to electrical energy by combustion, using a gas turbine, a reciprocating piston machine, a turbine generator set or a fuel cell, for example.

The problem on which the invention is based is that of specifying a method for converting electrical energy that combines an ideally high efficiency, incorporating both electrical and caloric energies, with an ideally low fresh water demand.

### SUMMARY OF INVENTION

The problem is solved by a method having the features of the claims.

As far as the withdrawal of energy from the energy converter of the invention is concerned, after conversion of fuel gas, especially hydrogen, and oxygen into water, the heat of condensation from the exhaust gas (from, for example, the gas turbine or the cathode of a PEM fuel cell) is utilized as a heat source for a heat pump in order to provide heat having a useful temperature, as process heat, in a (district) heating system, for example.

Through the inventive use of a heat pump and utilization of the process heat provided, a significant increase is achieved in the degree of utilization of the fuel, with the possible potential comprising the difference between the higher calorific value of 142 KJ/kg and the lower calorific value of 120 KJ/kg, corresponding to an efficiency boost of around 18.3 percent.

The condensation of the water from the exhaust gas provides for water recovery, with the water being stored, optionally treated and/or mixed with fresh water, and used again as an electrolyzer feed.

The inventive recycling of condensate from the exhaust gas as feed water for the electrolyzer produces a significant decrease in fresh water demand (>90 percent). Advantageous developments of the invention are specified in the dependent claims.

In a development of the invention, the heat pump utilizes additional heat sources.

On loading of the energy store of the invention, the cooling medium, especially cooling water, and the heat of the product flow from the electrolyzer can be utilized.

On unloading of the energy store of the invention, the cooling water of the combined heat and power unit CHP (directly as well as the heat of condensation) can be utilized.

In a development of the invention, a small part of the water from the circuit may be replaced by fresh water in order to avoid increasing the concentration of impurities in the system.

### BRIEF DESCRIPTION OF THE DRAWINGS

The invention is elucidated in more detail below as an exemplary embodiment, to an extent required for appreciation, by means of a FIGURE. In the FIGURE:

The sole FIGURE shows an energy provision facility that realizes the method of the invention.

### DETAILED DESCRIPTION OF INVENTION

The energy provision facility shown in the FIGURE is able to store supplied electrical energy IP (input power) as hydrogen H and to convert fuel gas H, NG into electrical energy, possibly at a later point in time. In the energy provision facility, on the one hand, supplied electrical energy IP is stored in chemically bound form as hydrogen H and, on the other hand, chemically bound energy, such as hydrogen H or natural gas NG, for example, is converted in a conversion stage CHP, CCPP, FC into useful energy, especially electrical current OP (output power). The chemically bound energy may be converted by a combined heat and power unit CHP, or a combined cycle power plant (CCPP) or gas and steam turbine power plant G+S, which is supplied with chemically bound energy on the input side in the form of hydrogen H, natural gas NG or a mixture of both. The chemically bound energy may also be converted by a fuel cell FC which is fed with hydrogen H. Where the chemically bound energy takes the form of natural gas NG, hydrogen H is obtained from the natural gas NG in an upstream stage (not represented), such as a reformer, more particularly a steam reformer, for example, and this hydrogen H is supplied to the fuel cell on the input side. The fuel cell may take the form of a PEM fuel cell, which may also be termed a proton exchange membrane fuel cell or polymer electrolyte fuel cell and which as a low-temperature fuel cell operates at about 80 degrees Celsius.

An electrolyzer ELY converts supplied electrical current IP (input power) into hydrogen H with consumption of water W, this hydrogen H being supplied either directly or, preferably, with temporary storage in a hydrogen store HS (hydrogen storage) to the conversion stage CHP, CCPP, FC.

In the hydrogen store HS, the hydrogen may be stored in gas form, optionally under a pressure of several hundred bars, as liquid, optionally by cooling to below the liquefaction temperature, or in chemically bound form in a metal hydride.

The water W supplied to the electrolyzer ELY is brought beforehand in a water treatment stage WT to the quality specification necessary for the electrolyzer.

The conversion stage CHP, CCPP, FC gives off exhaust gas EG which has a temperature above ambient temperature and above the dew point and which contains water in vapor form. The exhaust gas EG is cooled by an exhaust gas heat exchanger EGHE to below the condensation temperature of the exhaust gas EG (below the dew point). The cooling in the exhaust gas heat exchanger EGHE is accomplished by supply of heat to the cold heat entry port of a heat pump HP which on its hot output side feeds a process heat exchanger PHE. The heat delivered by the heat exchanger PHE is available as useful heat or process heat HC (heat consumer) for universal usage. The heat pump HP may be constructed according to the compressor principle, the absorber principle or the Peltier principle.

In the exhaust gas heat exchanger EGHE, the water from the cooled exhaust gas EG is deposited as condensate C and supplied to a water store WS, with vapors PS (purge stream) being deposited.

The condensate C cached in the water store WS feeds the water treatment stage WT. To compensate for quantities of water lost during circulation via the electrolyzer ELY, the conversion stage (CHP, CCPP, FC), the exhaust gas EG and the deposition of condensate in the exhaust gas heat exchanger EGHE, the water treatment stage WT is supplied with fresh water FW.

To avoid any increase in the concentration of impurities in the water circuit system, a proportion of the water may be cyclically or continuously removed from the circuit and replaced by fresh water FW.

The facility of the invention for converting electrical energy may be used for temporary storage, either in the short term over seconds or in the long term over days.

Without any requirement for temporary storage of hydrogen generated in the electrolyzer Ely, the facility of the invention for converting electrical energy may be used to loosely couple two different electrical current systems, with galvanic separation, examples being current systems with different frequencies, current systems with different phases, current systems with different voltages, AC/AC, DC/AC, AC/DC, 50 Hz/60 Hz, 60 Hz/50 Hz, DC/DC.

The present invention has been elucidated in detail for explanatory purposes with reference to specific exemplary embodiments. Here, elements of the individual exemplary embodiments may also be combined with one another. The invention is therefore not intended to be limited to individual exemplary embodiment, but merely to be limited by the appended claims.

### LIST OF REFERENCE SIGNS

AC Alternating current
C Condensate
CCPP Combined cycle power plant
CHP Combined heat and power plant
DC Direct current
EG Exhaust gas
EGHE Exhaust gas heat exchanger
ELY Electrolyzer
FC Fuel cell
FW Fresh water
G+S Gas and steam power plant
H Hydrogen
H, NG Fuel gas
HC Useful heat, process heat
HS Hydrogen store
Hz Frequency
IP Supplied electrical energy
NG Natural gas
OP Generated electrical energy
PHE Process heat exchanger
PS Vapors
WS Water store

1. A method for efficient conversion and provision of energy, comprising:
converting fuel gas (H, NG) into electrical energy (OP) in a conversion stage (CHP, CCPP, FC),
cooling an exhaust gas (EG) given off by the conversion stage (CHP, CCPP, FC) in an exhaust gas heat exchanger (EGHE) and condensing water vapor contained in the exhaust gas (EG) out to form condensate (C),
generating hydrogen (H) by an electrolyzer (ELY), with supply of electrical energy (IP) and at least predominant supply of the condensate (C),
supplying the hydrogen (H) to the conversion stage (CHP, CCPP, FC) as fuel gas,
cooling the exhaust gas heat exchanger (EGHE) by a heat pump (HP),
delivering by the heat pump (HP) a quantity of heat accommodated in the exhaust gas heat exchanger (EGHE) at an increased temperature level as useful heat (HC).

2. The method as claimed in claim 1,
wherein the hydrogen (H) is temporarily stored in a hydrogen store (HS).

3. The method as claimed in claim 1,
wherein the heat given off by the electrolyzer (ELY) is supplied to a cold heat entry port of the heat pump (HP).

4. The method as claimed in claim 1,
wherein the heat from the hydrogen (H) flowing out of the electrolyzer (ELY) is supplied to a cold heat entry port of the heat pump (HP).

5. The method as claimed in claim 1,
wherein the heat given off by the conversion stage (CHP, CCPP, FC) is supplied to a cold heat entry port of the heat pump (HP).

6. The method as claimed in claim 1,
wherein the condensate (C) supplied to the electrolyzer (ELY) passes through a water treatment stage (WT).

7. The method as claimed in claim 1,
wherein a quantity of circulated water (W) lost is supplemented by fresh water (FW).

8. The method as claimed in claim 1,
wherein a proportion of the circulated water (W) is continuously replaced by fresh water (FW).

9. The method as claimed in claim 1,
wherein a proportion of the circulated water (W) is cyclically replaced by fresh water (FW).

10. The method as claimed in claim 1,
wherein the conversion stage takes the form of a combined cycle power plant (CCPP).

11. The method as claimed in claim 1,
wherein the conversion stage takes the form of a combined heat and power plant (CHP).

12. The method as claimed in claim 1,
wherein the conversion stage takes the form of a fuel cell (FC).

13. The method as claimed in claim 1,
wherein the conversion stage is supplied with natural gas (NG) as fuel gas.

14. The method as claimed in claim 1,
wherein the energy comprises electrical energy.
